(19) United States
(12) Patent Application Publication
(10) Pub. No.: US 2006/0195873 A1
(43) Pub. Date: Aug. 31, 2006

(54) Mechanism for sharing control of a tuner amongst multiple video consuming entities

(75) Inventors: Krishnan Gopalan, Bellevue, WA (US); Nishad Mulye, Redmond, WA (US); Matthew S. McCormick, Seattle, WA (US); Luke Wabaunsee McCullough, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/065,763

(22) Filed: Feb. 25, 2005

(51) Int. Cl. H04N 7/173; H04N 7/16

(52) U.S. Cl. 725/100; 725/131; 725/151

(57) ABSTRACT

Automated sharing of control of a single tuner amongst multiple video consuming entities. One of the video consuming entities is assigned to be primary, thereby allowing seamless control over the channel tuned by the tuner. Another of the video consuming entities is assigned to be secondary, which prohibits the seamless control of the channel tuned by the tuner (at least while the assignment of secondary applies to the secondary video consuming entity). Promotion rules are applied to determine whether or not the secondary video consuming entity should be promoted to primary. The promotion rules only allow one video consuming entity at a time to be assigned as primary for the tuner. If appropriate, the secondary video consuming entity is then promoted to primary. The promotion rules may enforce any desired policy regarding conflict resolution on the tuner.

### BACKGROUND OF THE INVENTION

1. The Field of the Invention

The present invention relates to video technology; and more specifically, to mechanisms for sharing control of a tuner amongst multiple competing and independent video consuming entities.

2. Background and Related Art

Video has become a major form of communication. One of the primary sources for video information are television signals. Regardless of its source, the video signals may contain multiple channels. A tuner receives the video signals and may be controlled to tune to one of the channels. The resulting video may then be consumed by multiple video consuming entities. Examples of video consuming entities may include video recorders or displays.

Multiple video consuming entities may simultaneously access a single channel of video tuner by a single tuner. For example, a user may watch video rendered on a display while the video is also being recorded. However, multiple video consuming entities cannot consume video from different channels simultaneously using the same tuner, since the tuner is limited to tuning to only one channel at a time.

### BRIEF SUMMARY OF THE INVENTION

The foregoing problems with the prior state of the art are overcome by the principles of the present invention, which allows for multiple video consuming entities to share control of a tuner that is only able to tune to one channel at a time. One of the video consuming entities is assigned to be “primary”, which allows the video consuming entity seamless control over the channel tuned by the tuner. Another of the video consuming entities is assigned to be “secondary”, which prohibits the seamless control of the channel tuned by the tuner (at least while the assignment of secondary applies to the secondary video consuming entity).

At some point, promotion rules are applied to determine that the secondary video consuming entity should be promoted to primary. The promotion rules only allow one video consuming entity at a time to be assigned as primary for the tuner. If appropriate, the secondary video consuming entity is then promoted to primary. The promotion rules may enforce any desired policy regarding conflict resolution on the tuner. Accordingly, the tuner may be shared amongst multiple video consuming entities in an intelligent fashion.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 schematically illustrates an environment in which multiple video consuming entity may contend for control of a single tuner;

FIG. 2 schematically illustrates a computer system that may service as a video consuming entity when the video processing logic of the video consuming entity is performed using software; and

FIG. 3 illustrates a flowchart of a method for sharing control of the tuner between the multiple video consuming entities in accordance with the principles of the present invention.

### DETAILED DESCRIPTION OF THE PREFERRED EMBODIMENTS

The principles of the present invention allow multiple video consuming entities to share control of a tuner that is only able to tune to one channel at a time. One of the video consuming entities is assigned to be “primary”, which allows the video consuming entity seamless control over the channel tuned by the tuner. Another of the video consuming entities is assigned to be “secondary”, which prohibits the seamless control of the channel tuned by the tuner (at least while the assignment of secondary applies to the secondary video consuming entity). Promotion rules are applied to determine whether or not the secondary video consuming entity should be promoted to primary. The promotion rules only allow one video consuming entity at a time to be assigned as primary for the tuner. If appropriate, the secondary video consuming entity is then promoted to primary. The promotion rules may enforce any desired policy regarding conflict resolution on the tuner.

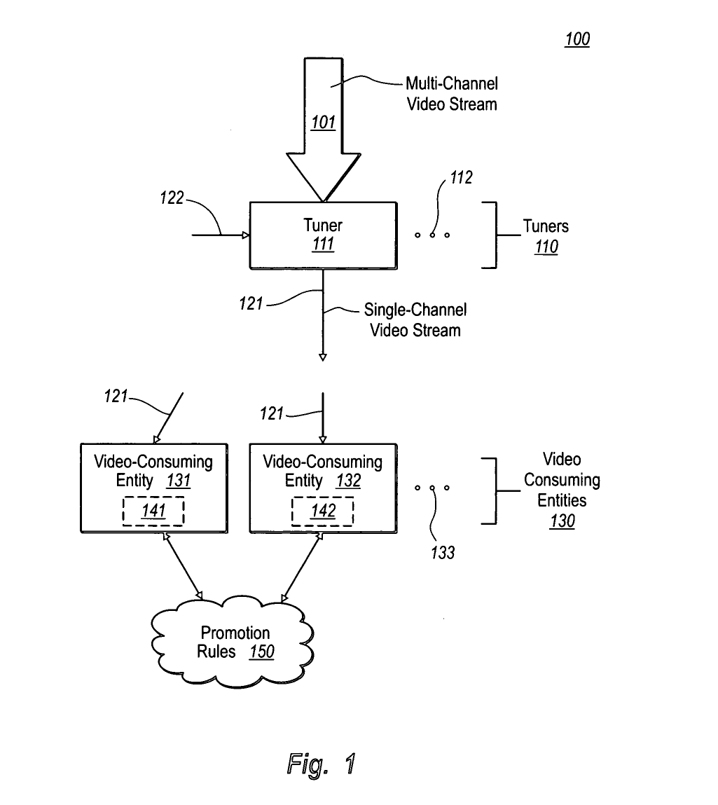

FIG. 1 illustrates an environment 100 in which the principles of the present invention may be employed. The environment 100 includes an incoming multi-channel video stream 101, which may be received via any broadband medium such as, for example, cable, satellite, terrestrial airwaves, or even over a Local Area Network (LAN) or Internet connections.

The multi-channel video stream 101 may be received at one or more tuners 110. The tuner(s) 110 are illustrated as including tuner 111, amongst potentially others as represented by the horizontal ellipses 112. The tuner 111 is configured to tune to one of the channels of the multi-channel video stream 101, and provide the resulting single-channel video stream 121 to one or more video consuming entities 130. The particular channel that is tuned by tuner 111 is controlled via a control signal 122. Other tuners may similar tune to particular channels. Nevertheless, any given tuner is configured to tune to only one channel at a time, and thus the tuner may be considered a limited resource.

The one or more video consuming entities 130 are illustrated as including at least video consuming entity 131 and video consuming entity 132. However, there may be other video consuming entities as represented by horizontal ellipses 133. Examples of video consuming entities include video recorders and video displays. Each of the corresponding video consuming entities may have corresponding logic, which may be implemented in hardware, software, or a combination of hardware and software.

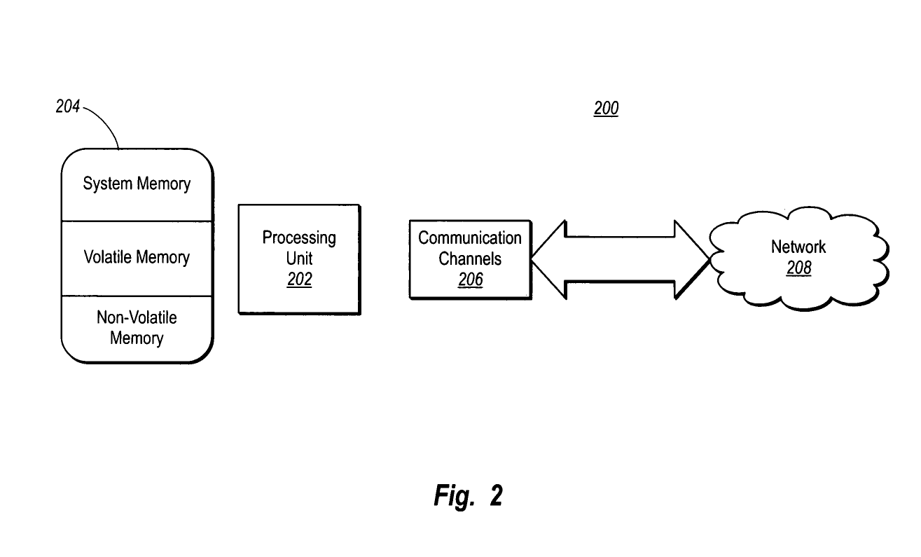

If the logic is at least partially implemented in software, the video consuming entity may be structure as shown in FIG. 2. In its most basic configuration, such a video consuming entity may be composed of a computing system 200 that includes at least one processing unit 202 and memory 204. The memory 204 may be volatile (such as RAM), non-volatile (such as ROM, flash memory, disk or optical drive, or the like), or some combination of the two. Computing system 200 may also contain communication channels 206 that allow the video consuming entity to interface with other video consuming entities over network 208 for a variety of purposes including distributed control of the tuner when multiple video consuming entities are contending for control of the same tuner. The communications channels 206 may also be used to receive the single-channel video stream from the tuner.

Communication channels 206 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

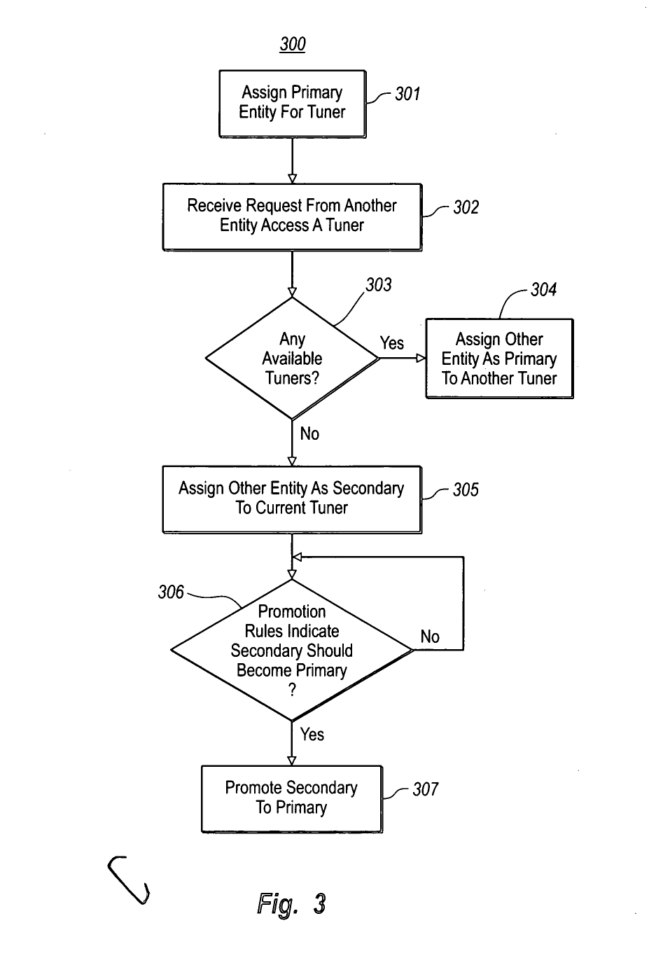

The video processing logic is illustrated in FIG. 1 as being dashed boxes. For example, video consuming entity 131 has corresponding video processing logic 141, and video consuming entity 132 has corresponding video processing logic 142. For example, such video processing logic may be configured to pause rendering or recording of any received single-channel video stream 121, rewind rendering through the video stream, or fast-forward rendering through the video stream back to the point of being live. In addition, the video processing logic may be configured to perform the logic that will now be described with respect to FIG. 3 when multiple video consuming entities are attempting to control the same tuner in a conflicting manner. The video processing logic may be present locally on the video consuming entity, or may be remotely located.

In particular, FIG. 3 illustrates a flowchart of a method 300 for sharing control of the tuner between the multiple video consuming entities in accordance with the principles of the present invention. Initially, a tuner (hereinafter referred to as a “current tuner”) is not in use by any video consuming entity. When the first attempt to control the tuner is received, the video processing logic assigns the requesting video consuming entities to be primary (act 301). Suppose, for the time being, that video consuming entity 131 first requests control of the tuner 111. The video processing logic assigns the video consuming entity 131 to be primary.

This “primary” assignment means that the video consuming entity is permitted to “seamlessly” control the channel tuned to by the tuner. “Seamlessly” means that the entity may control the channel by issuing a single instruction to change the channel. Of course, the primary video computing entity 131 may continue to perform other functions on the received single channel video stream 121 using video processing logic 141, such as pause, rewind, fast-forward, and the like.

Up until this point, there is no contention for control of the tuner. Subsequently, however, there is another attempt to control a tuner received by the system (act 302). For instance, video consuming entity 132 may attempt to control a tuner (e.g., by beginning a scheduled or impromptu video recording, or by attempting to tune to a channel that is not already tuned to).

If there are other tuners available (Yes in decision block 303), then the other video consuming entity is permitted to control another tuner by, for example, being assigned as the primary video consuming entity for another tuner (act 304). Note that the “available” tuners for this other video consuming entity may not include all of the unused tuners, since there may be some restrictions imposed on what video consuming entity may control what tuner.

If there are no other tuners available (No in decision block 303), then the other video consuming entity is assigned at least temporarily as “secondary” for the tuner (act 305). For example, if all of the tuners 110 are in use, the video consuming entity 132 may be assigned as the secondary video consuming computing entity for the tuner 111. In the example, the user of the video consuming entity 132 may elect to view the same channel as is currently being consumed by the video consuming entity 131.

From a user standpoint, this may be accomplished by attempting to tune to a channel. In response a dialog is displayed to the user explaining something to the effect that all tuners are currently in use. The user may also be displayed a list of possible channels corresponding to channels already being tuned to. This list may be updated dynamically when the channel is changed for other tuner. The secondary video consuming entity may then join in on displaying a channel that is already tuned to. If, prior to selecting to share a currently-used tuner, one of the tuner's becomes available, the displayed dialog may simply disappear, the other video consuming entity may then be assigned as primary to the newly available tuner, and the original tuning request of the other video consuming entity may be honored.

The secondary video consuming entity is limited in that it cannot seamlessly change the channel tuned to without taking control from the primary video consuming entity. However, the secondary video consuming entity may still perform other video processing that uniquely affects the viewing experience at the secondary video consuming entity. For example, the associated video processing logic may permit pausing, fast-forwarding, and rewinding of the rendering of the single-channel video stream independent of the primary video consuming entity.

A given tuner may have multiple secondary video consuming entities by repeating act 302, NO in decision block 303 and act 305. For any given secondary video consuming entity, promotion rules are applied periodically, continuously, and/or in response to a particular event(s). Such promotion rules are used to determine when and if the corresponding secondary video consuming entity should be promoted to primary (decision block 306). Since the tuner can have only one primary, the promotion rules only allow one video consuming entity at a time to be assigned as primary for the tuner. If promotion is appropriate (YES in decision block 306), then the secondary video consuming entity is promoted to primary (act 307).

The promotion rules may be specifically tailored with particular goals and circumstances in mind. In that light, there are a number of events or circumstances that may warrant the promotion of a secondary video consuming entity to a primary video consuming entity. The promotion rules are illustrated in FIG. 1 as promotion rules 150, which may be distributed across all video consuming entities, or may be specific to each video consuming entity.

For example, the primary video consuming entity may indicate that the promotion is appropriate if the primary video consuming entity ceases consuming video from the tuner. If the primary video consuming entity was a video recorder (e.g., a digital video recorder), perhaps the recording period has ended. If the primary video consuming entity was a video display, perhaps the user has turned the display off or traveled away from the display. In the case where a single tuner has multiple secondary video consuming entities using the video provided by the tuner, there may be specific rules regarding which secondary video consuming entity is to be promoted. Perhaps the first still-active video consuming entity to be assigned as secondary for that tuner is promoted to primary.

The promotion rules may even permit promotion even if the primary video consuming entity was still consuming the video. For example, if the secondary video consuming entity were to attempt to change the channel to a channel not tuned by any of the tuners, the user may be displayed a dialog, which simply gives the user a choice as to whether to take over the primary position. The dialog may also indicate certain details about the current primary consuming entity to allow for an intelligent decision on whether or not to take over the primary control. Such information may include, for example, whether or not the primary video consuming entity is a recorder or a display or other viewer. If a display, it may show who the viewer is, information about the video being viewed, and the like.

The promotion rules may allow the secondary video consuming computing system to take primary control even without any independent user choice. Such a decision may be based on priority of the associated user. For example, a parent may be given priority over a child such that a video consuming entity that has a parent as a user always takes the primary position from a video consuming entity that has a child as a user. The identity of a user may be determined by, for example, entering a code into the video consuming entity, through proximity detection devices that travel with the user, by retinal or fingerprint scan, or the like.

If the promotion rules produce some undesired result, or the circumstances change over time, the promotion rules may be configured to change over time. For example, an administrator (e.g., a parent) may decide what promotion rules are to be applied. For instance, the promotion rules may be represented in a known schema that is interpretable by the video processing logic. Accordingly, wide-ranging conflict resolution governing control of a tuner is enabled.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In an environment in which there is a tuner configured to tune to one channel: of video service at a time, and multiple video consuming entities that may consecutively control the tuner, a method for sharing control of the tuner between the multiple video consuming entities, the method comprising the following:
an act of assigning one of the video consuming entities to be primary, wherein the assignment of primary allows the primary video consuming entity to seamlessly control the channel tuned to by the tuner;
an act of assigning another of the video consuming entities to be secondary, wherein the assignment of secondary prohibits the secondary video consuming entity from seamlessly controlling the channel tuned by the tuner while the assignment of secondary applies to the secondary video consuming entity;
an act of applying promotion rules to determine that the secondary video consuming entity should be promoted to primary, wherein the promotion rules only allow one video consuming entity at a time to be assigned as primary for the tuner; and
an act of promoting the secondary video consuming entity to primary.

2. A method in accordance with claim 1, wherein the promotion rules indicate that the secondary video consuming entity should be promoted to primary if the primary video consuming entity ceases consuming video from the tuner.

3. A method in accordance with claim 1, wherein the promotion rules indicate that the secondary video consuming entity should be promoted to primary if the primary video consuming entity ceases consuming video from the tuner, and if there are no other secondary video consuming entities ahead of the secondary video consuming entity in priority for controlling the tuner.

4. A method in accordance with claim 1, wherein the promotion rules indicate that the secondary video consuming entity should be promoted if an instruction from a user of the secondary video consuming entity is received indicating that the secondary video consuming entity is to take control of the tuner.

5. A method in accordance with claim 1, wherein the promotion rules indicate that the secondary video consuming entity should be promoted if an identified user of the secondary video consuming entity is identified as having priority control privileges over an identified user of the primary video consuming entity.

6. A method in accordance with claim 1, wherein the environment includes a plurality of tuners, and the act of assigning another of the video consuming entities to be secondary occurs only after the following:
an act of determining that all other of the plurality of tuners are already being controlled by a video consuming entity.

7. A method in accordance with claim 1, wherein the secondary video consuming entity is a video display.

8. A method in accordance with claim 1, wherein the secondary video consuming entity is a video recorder.

9. A method in accordance with claim 1, wherein the secondary video consuming entity is permitted to control rendering of the tuned video at the secondary video consuming entity, even though the secondary video consuming entity cannot seamlessly control the channel tuned by the tuner.

10. A method in accordance with claim 9, wherein secondary video consuming entity is permitted to independently control the rendering of the tuned video without controlling rendering of the tuned video at the primary video consuming entity.

11. A computer program product for use in an environment in which there is a tuner configured to tune to one channel of video service at a time, and multiple video consuming entities that may consecutively control the tuner, the computer program product comprising one or more computer-readable media having thereon computer-executable instructions that, when executed by one or more processors of the video consuming entities, causes the video consuming entities to perform a method for sharing control of the tuner between the multiple video consuming entities, the method comprising the following:
an act of assigning one of the video consuming entities to be primary, wherein the assignment of primary allows the primary video consuming entity to seamlessly control the channel tuned to by the tuner;
an act of assigning another of the video consuming entities to be secondary, wherein the assignment of secondary prohibits the secondary video consuming entity from seamlessly controlling the channel tuned by the tuner while the assignment of secondary applies to the secondary video consuming entity;
an act of applying promotion rules to determine that the secondary video consuming entity should be promoted to primary, wherein the promotion rules only allow one video consuming entity at a time to be assigned as primary for the tuner; and
an act of promoting the secondary video consuming entity to primary.

12. A computer program product in accordance with claim 11, wherein the promotion rules indicate that the secondary video consuming entity should be promoted to primary if the primary video consuming entity ceases consuming video from the tuner.

13. A computer program product in accordance with claim 11, wherein the promotion rules indicate that the secondary video consuming entity should be promoted to primary if the primary video consuming entity ceases consuming video from the tuner, and if there are no other secondary video consuming entities ahead of the secondary video consuming entity in priority for controlling the tuner.

14. A computer program product in accordance with claim 11, wherein the promotion rules indicate that the secondary video consuming entity should be promoted if an instruction from a user of the secondary video consuming entity is received indicating that the secondary video consuming entity is to take control of the tuner.

15. A computer program product in accordance with claim 11, wherein the promotion rules indicate that the secondary video consuming entity should be promoted if an identified user of the secondary video consuming entity is identified as having priority control privileges over an identified user of the primary video consuming entity.

16. A computer program product in accordance with claim 11, wherein the environment includes a plurality of tuners, and the act of assigning another of the video consuming entities to be secondary occurs only after the following:
an act of determining that all other of the plurality of tuners are already being controlled by a video consuming entity.

17. A computer program product in accordance with claim 11, wherein the secondary video consuming entity is a video display.

18. A computer program product in accordance with claim 11, wherein the secondary video consuming entity is a video recorder.

19. A computer program product in accordance with claim 11, wherein the computer-executable instructions permit the secondary video consuming entity to control rendering of the tuned video at the secondary video consuming entity, even though the secondary video consuming entity cannot seamlessly control the channel tuned by the tuner.

20. A computer program product in accordance with claim 19, wherein the computer-executable instructions permit the secondary video consuming entity to independently control the rendering of the tuned video without controlling rendering of the tuned video at the primary video consuming entity.
